(19) United States
(12) Patent Application Publication
(10) Pub. No.: US 2004/0219259 A1
(43) Pub. Date: Nov. 4, 2004

(54) Diesters of astaxanthin for enhancing the growth of farmed fish

(76) Inventors: Harald Breivik, Skjelsvik (NO); Lola Irene Sanna, Porsgrunn (NO); Berit Annie Aanesen, Skien (NO)

Correspondence Address: FITZPATRICK CELLA HARPER & SCINTO, 30 ROCKEFELLER PLAZA, NEW YORK, NY, 10112, US

(21) Appl. No.: 10/482,839

(22) PCT Filed: Jul. 3, 2002
(86) PCT No.: PCT/NO02/00246

(51) Int. Cl. A01K 1/00

(52) U.S. Cl. 426/2

(57) ABSTRACT

This invention relates to the use of diesters of astaxanthin prepared with omega-3 fatty acids and/or short chain carboxylic acids for enhancing the growth of farmed fish, as a growth-enhancing agent in feed for farmed fish, as an appetizer in feed for fish as well as for increasing the utilization of the feed for farmed fish, and for optimising health and well-being of farmed fish.

This invention relates to the use of diesters of astaxanthin prepared with omega-3 fatty acids and/or short chain carboxylic acids for enhancing the growth of farmed fish.

In the aquaculture industry it is a continual focus on the growth of the fish. It is a goal to produce healthy fish that rapidly gain weight and thereby obtain a satisfying slaughtering weight in a minimum of time.

To improve on this goal a lot of effort is put in development of feed for farmed fish. However, there are still a need for more an optimised feed.

In Norwegian patent application No. 1999 1857 it is disclosed that diesters of astaxanthin prepared with omega-3 fatty acids and/or short chain carboxylic acids have excellent properties as a pigment in feed for salmonides.

Now the inventors of the present invention surprisingly have found that a feed comprising diesters of astaxanthin prepared with omega-3 fatty acids and/or short chain carboxylic acids exhibit unexpected results concerning the growth of salmonides. The person skilled in the art will realise that the growth-enhancing effects will be of great value also for fish species other than those where astaxanthin is given for pigmentation of the flesh. The present invention is intended for all fish species that are reared in aquaculture.

Thus, it is a main object of the present invention to provide a growth-enhancing agent for feed to farmed fish.

Another object of this invention is to provide a feed that improves the uptake of the feed in the fish.

Still another object of this invention is to provide a feed that is more appetizing for the fish.

These and other objects are achieved by the attached claims.

The invention is further explained by examples.

The person skilled in the art will know that improved growth is linked to improved health and well-being of the fish. Thus the present invention also provides a feed that gives an optimised health and well-being of farmed fish.

### EXAMPLE 1

Diester of astaxanthin was prepared with a concentrate of omega-3 fatty acids comprising approximately 50% eicosapentaenoic acid (EPA) (all cis C20:5 n3) and approximately 35% docosahexaenoic acid (DHA) (all cis C22:6 n3).

The EPA/DHA astaxanthin diester (ACD) above (30 mg/kg calculated as free (i.e. unesterified) astaxanthin) was added during pilot plant production of fish fodder according to a standard recipe. The fat content of the fodder was approx. 35%. Urea is (0.7% by weight) was added with water during extrudation. ACD was added together with fish oil by vacuum-coating of the extruded pellets. Several batches of this fodder composition were produced.

Commercial astaxanthin (Carophyll Pink, Roche, 30 mg/kg calculated as free astaxanthin) was added to fish fodder in the same manner as above. In this commercial product unesterified astaxanthin is finely dispersed in a starch-covered matrix of gelatine and carbohydrates. Ethoxyquin and ascorbyl palmitate are added as antioxidants. The process and raw materials, including urea addition, were identical with what is given above. Several batches of these fodder compositions were produced (one with and one without added urea).

Urea was added in order to study whether this had an effect on fodder quality. The calculations related to utilisation of feed (table 3) are not corrected for the small weight contribution of urea (0.7%).

The three fodder compositions were given to Atlantic salmon. Initially, the average weight of the fish was 68 grams for all groups. Initially, there was 800 fish in each group. After 11.5 months the number was reduced to approx. 300 fish in each group. The fish were fed manually ad libido. Table 1 and 2 below show the weight development in the different groups.

TABLE 1
Average weight (g):

| Time | Control | Control with urea | ACD |
|---|---|---|---|
| 8 months | 1132 | 1153 | 1180 |
| 11.5 months | 1345 | 1402 | 1437 |
| 15.5 months | 3967 | 4078 | 4320 |

TABLE 2
Average weight relative to control:

| Time | Control | Control with urea | ACD |
|---|---|---|---|
| 8 months | 1.00 | 1.02 | 1.04 |
| 11.5 months | 1.00 | 1.04 | 1.07 |
| 15.5 months | 1.00 | 1.03 | 1.09 |

Utilisation of Feed

After 11.5 months the number of fish in each group was reduced to approx. 300. Table 3 below shows the weight increase related to fodder consumption:

TABLE 3

| | Control | Control with urea | ACD |
|---|---|---|---|
| Average weight | 3.967 | 4.078 | 4.320 |
| (kg) | | | |
| Number of | 296 | 293 | 294 |
| fish: Increase | 776.1 | 784.1 | 847.6 |
| of biomass(kg) | | | |
| from 11.5 | | | |
| months | | | |
| Fodder con- | 875.5 | 888.8 | 906.9 |
| sumption (kg) | | | |
| from 11.5 | | | |
| months | | | |
| Increase of bio- | 0.8865 (1.00) | 0.8822 (1.00) | 0.9347 (1.05) |
| mass/fodder | | | |
| (relative to | | | |
| control) | | | |

The results show that ACD gives an increase of weight compared to that of the control. The increase is also higher than the control plus urea (Table 1 and 2). The increase of weight seems partly to be due to a better utilisation of the fodder. Addition of urea alone does not seem to have any effect in this respect (Table 3).

1. A process of enhancing the growth of farmed fish comprising feeding to the fish a feed that contains a diester of astaxanthin prepared with at least one esterifying acid selected from the group consisting of omega-3 fatty acids and short chain carboxylic acids.

2-5. (Cancelled)

6. The process of claim 1, wherein 18 to 100% of the esterifying acid is composed of one or more omega-3 fatty acids selected from the group consisting of eicosapentaenoic acid (EPA) (all cis C20:5 n3) and docosahexaenoic acid (DHA) (all cis C22:6 n3).

7. The process of claim 1, wherein 40 to 100% of the esterifying acid is composed of one or more omega-3 fatty acids selected from the group consisting of eicosapentaenoic acid (EPA) (all cis C20:5 n3) and docosahexaenoic acid (DHA) (all cis C22:6 n3).

8. The process of claim 1, wherein 8 to 98% of the esterifying acid is eicosapentaenoic acid (EPA) (all cis C20:5 n3) and 8 to 98% of the esterifying acid is docosahexaenoic acid (DHA) (all cis C22:6 n3).

9. The process of claim 1, wherein 25 to 98% of the esterifying acid is eicosapentaenoic acid (EPA) (all cis C20:5 n3) and 15 to 98% of the esterifying acid is docosahexaenoic acid (DHA) (all cis C22:6 n3).

10. The process of claim 1 wherein approximately 50% of the esterifying acid is eicosapentaenoic acid (EPA) (all cis C20:5 n3) and approximately 35% of the esterifying acid is docosahexaenoic acid (DHA) (all cis C22:6 n3).

11. The process of claim 1, wherein the short chain carboxylic acid contains from 1-12 carbon atoms.

12. The process of claim 11, wherein the short chain carboxylic acid is formic acid.

13. The process according to any of claims 1 and 6-12, wherein the farmed fish are salmonides.
